(19) United States
(12) Patent Application Publication
(10) Pub. No.: US 2010/0246181 A1
(43) Pub. Date: Sep. 30, 2010

(54) LED LAMP

(75) Inventors: HAI-MING FANG, Shenzhen City (CN); YONG-DONG CHEN, Shenzhen City (CN); SHIH-HSUN WUNG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/494,335

(22) Filed: Jun. 30, 2009

(30) Foreign Application Priority Data
Mar. 24, 2009 (CN) 200910301080.3

(51) Int. Cl. F21S 6/00; F21V 17/00

(52) U.S. Cl. 362/257; 362/375

(57) ABSTRACT

A light emitting diode (LED) lamp, includes casing and an LED module received in the casing. The casing defines a light-outputting opening in a bottom thereof and has a plurality of fixing parts which are formed at two facing inner sides of the casing and spaced from the light-outputting opening with different distances. The LED module is selectively fixed to one of the fixing parts. Therefore, a distance between the LED module and the light-outputting opening is adjustable by selectively fixing the LED module to different one of the fixing parts.

### BACKGROUND

1. Technical Field

The present disclosure relates to a light emitting diode (LED) lamp, and particularly to an LED lamp having an adjustable illumination area and intensity.

2. Description of Related Art

With the continuing development of scientific technology, LEDs have been widely used for illumination due to their high brightness, long life-span, and wide color gamut.

An LED lamp is a type of solid-state lighting device that utilizes LEDs as a source of illumination.

A conventional LED lamp generally comprises a lamp cover and a plurality of LEDs attached to an inner wall of the lamp cover. However, the lamp can only be assembled in a predetermined form with its illumination area of light emitted by the LEDs of the conventional LED lamp restricted to a fixed value along a direction of the LED lamp. A problem is that the conventional LED lamp fails to provide an adjustable illumination area and illumination intensity of the light emitted by the LEDs. So the conventional LED lamp cannot satisfy a requirement that an illumination area and an illumination intensity of the LED lamp are variable, which may be required for some applications.

What is needed, therefore, is an LED lamp which can overcome the above-mentioned disadvantages.

### BRIEF DESCRIPTION OF THE DRAWINGS

Many aspects of the present apparatus can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is an assembled, isometric view of an LED amp in accordance with an embodiment of the present disclosure.

FIG. 2 is an inverted, exploded view of the LED lamp of FIG. 1.

FIG. 3 is an exploded view of the LED lamp of FIG. 1.

FIG. 4 is an enlarged view of an circled portion IV of FIG. 2.

FIG. 5 is an inverted, cutaway view of the LED lamp of FIG. 1.

### DETAILED DESCRIPTION

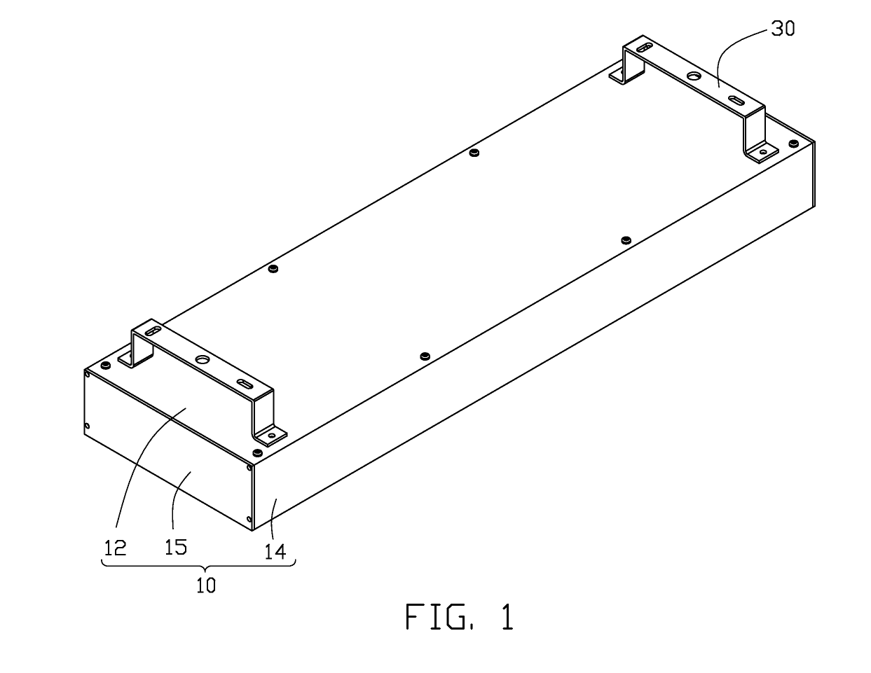

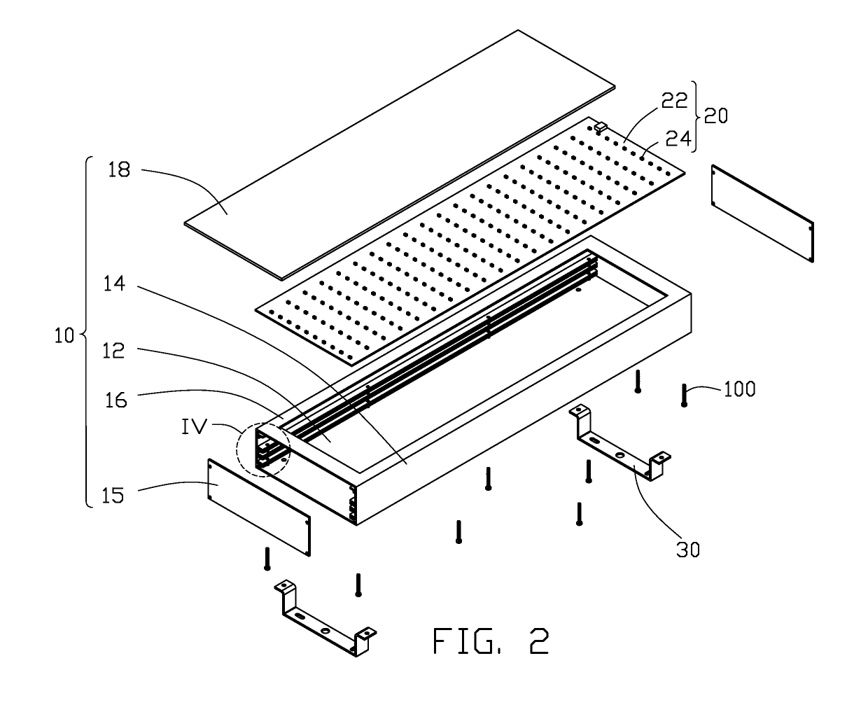

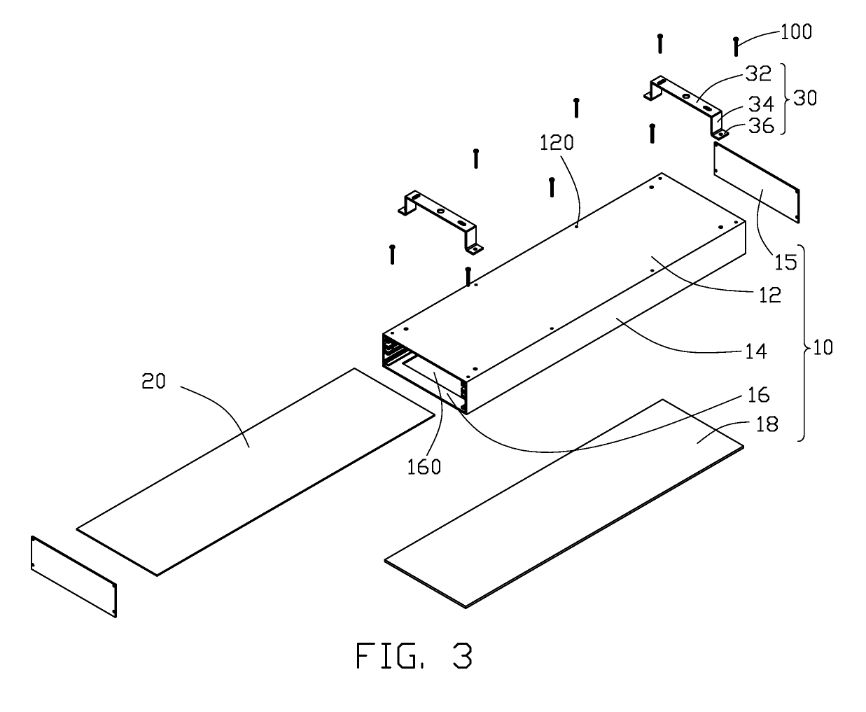

Referring to FIGS. 1-3, an LED lamp in accordance with an embodiment is illustrated. The LED lamp, which is configured for being held indoors or outdoor to provide illumination, comprises a casing 10, an LED module 20 mounted in the casing 10 and two fixing brackets 30 fixed on a top of the casing 10 for holding the LED lamp in place.

The casing 10 is cuboid-shaped and comprises a rectangular top plate 12, two side plates 14 extending downwardly from two opposite long side edges of the top plate 12, a bottom plate 16 connecting to two bottom edges of the two side plates 14, a rectangular lens 18 overlying a top (i.e., inner) surface of the bottom plate 16 and two end plates 15 fixed at two opposite ends of the casing 10.

The top plate 12 defines a plurality of extending holes 120 therein. The extending holes 120 are spaced from each other and adjacent to the two opposite long side edges of the top plate 12 for allowing fixtures 100 to extend therethrough. The bottom plate 16 parallel to the top plate 12 and defines a light-outputting opening 160 in a central part thereof. The opening 160 is rectangular, and has a size slightly smaller than that of the bottom plate 16. Light generated by the LED module 20 radiates to an outside of the LED lamp through a part of the lens 18 covering the opening 160. The opening 160 exposes most of the lens 18 overlying the top surface of the bottom plate 16 to the outside. The two end plates 15 are rectangular and fixed to opposite ends of the top, bottom and side plates 12, 16, 14 by screwing or soldering to define a room in the casing 10.

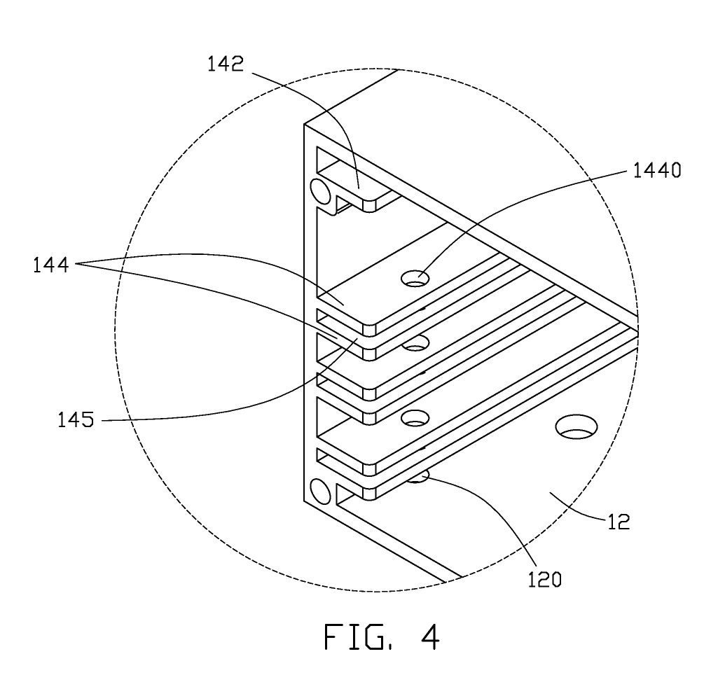

Also referring to FIG. 4, each side plate 14 perpendicular to the top plate 12 has a locking plate 142 extending inwardly and horizontally from an inner side thereof. The locking plate 142 of each side plate 14 is parallel to and separated from the bottom plate 16, and engages a top surface of the lens 18 to fix the lens 18 on the top surface of the bottom plate 16. A plurality of fixing parts are correspondingly formed at the two inner sides of the two side plates 14 and spaced from the light-outputting opening 160 of the bottom plate 16 with different distances for selectively fixing the LED module 20 in a place with a selected distance away from the opening 160. The fixing parts are arranged at the inner sides of the two side plates 14 along a direction parallel to the light-outputting opening 160 of the bottom plate 16. Each fixing part comprises two separated fixing plates 144 extending inwardly and horizontally from the inner side of a corresponding side plate 14. An elongated receiving slot 145 is defined between the two separated fixing plates 144 of each fixing part for receiving a lateral portion of the LED module 20 therein. The two fixing plates 144 of each fixing part define a plurality of fixing holes 1440. The fixing holes 1440 of each fixing plate 144 are spaced from each other and respectively in alignment with the extending holes 120 of the top plate 12 for engagingly receiving the fixtures 100 extending through the corresponding extending holes 120 of the top plate 12 therein. The lens 18 placed on the top surface of the bottom plate 16 is located between the two side plates 14 and covers the opening 160 of the bottom plate 16.

Each LED module 20 comprises a rectangular printed circuit board 22 and a plurality of LED components 24 mounted on a bottom surface of the printed circuit board 22. The printed circuit board 22 has a size similar to that of the lens and can be fitly received in the casing 10.

The two fixing brackets 30 are separated from each other and used for fixing the LED lamp to a ceiling (not shown) indoor or a fixing pole (not shown) outdoor. Each fixing bracket 30 comprises an elongated retaining part 32, two retaining legs 34 extending downwardly from two opposite ends of the retaining part 32 and two engaging parts 36 extending outwardly and horizontally from two bottom edges of the two retaining legs 34. The engaging parts 36 are attached to a top surface of the top plate 12 and secured by soldering or screwing.

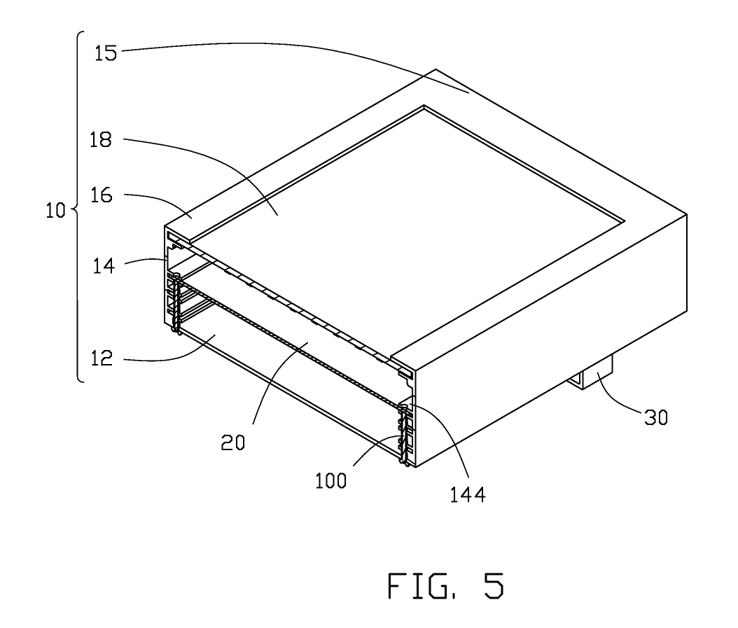

Referring to FIG. 5, in assembly of the LED lamp, the LED module 20 is inserted into the two corresponding ones of the receiving slots 145 of the two side plates 14 of the casing from an end of the casing 10. Two lateral portions of the printed circuit board 22 of the LED module 20 are sandwiched between the corresponding two pairs of fixing plates 144 spaced from the lens 18 with the same distance. The fixtures 100 are extended through the extending holes 120 of the top plate 12 of the casing 10 and screwed downwardly into the fixing holes 1440 of the fixing plates 144 until bottom ends of the fixtures 100 press on top surfaces of the two lateral portions of the printed circuit board 22, whereby the LED module 20 is securely locked in one of the fixing parts.

In use of the LED lamp, light emitted by the LED module 20 travels through the lens 18 and the opening 160 of the bottom plate 16 of the casing 10 to illuminate an area under the LED lamp. Intensity and illumination area of the LED lamp are both adjustable by selectively fixing the LED module 20 to one of different fixing parts of the casing 10 to obtain a desirable distance between the LED module 20 and the light-outputting opening 160 formed in a bottom of the casing 10. As the farther the LED module 20 spaces away from the light-outputting opening 160, the smaller the intensity and illumination area of the LED lamp are.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1 A light emitting diode (LED) lamp, comprising:
a casing defining a light-outputting opening in a bottom thereof and having a plurality of fixing parts which are formed at two facing inner sides of the casing and spaced from the light-outputting opening with different distances; and
an LED module received in the casing and fixed to one of the fixing parts and spacing form the light-outputting opening a distance;
wherein the distance between the LED module and the light-outputting opening is varied when the LED module is fixed to another one of the fixing parts of the casing.

2. The LED lamp as claimed in claim 1, wherein the fixing parts are arranged at the two facing inner sides of the casing along a direction parallel to the light-outputting opening.

3. The LED lamp as claimed in claim 1, wherein the fixing parts include a plurality of pairs of receiving slots, each pair of the receiving slots formed in two corresponding places of the two facing inner sides of the casing and provided for receiving two lateral portions of the LED module therein.

4. The LED lamp as claimed in claim 3, wherein the receiving slots are spaced from each other and parallel to the bottom of the casing.

5. The LED lamp as claimed in claim 4, wherein the casing comprises a top plate, two side plates extending downwardly from two opposite sides of the top plate and a bottom plate connecting two bottom edges of the two side plate.

6. The LED lamp as claimed in claim 5, wherein the light-outputting opening is defined in the bottom plate, the receiving slots are formed at two inner side walls of the two side plates.

7. The LED lamp as claimed in claim 6, wherein a plurality of pairs of fixing plates extend inwardly and horizontally from the inner side walls of the side plates, each pair of the fixing plates defining one of the receiving slots therebetween and provided for sandwiching one of the two lateral portions of the LED module therebetween.

8. The LED lamp as claimed in claim 7, wherein a plurality of fixtures are downwardly extended through a top of the casing and the fixing plates in sequence and engage a top surface of the LED module.

9. The LED lamp as claimed in claim 5, wherein the casing further comprises a lens overlying on a top surface of the bottom plate and covering the light-outputting opening, and two locking plates which extend inwardly and horizontally from the inner side walls of the two side plates and engage a top of the lens.

10. The LED lamp as claimed in claim 1, wherein the LED module comprises a printed circuit board received in the casing and a plurality of LED components mounted on a bottom surface of the printed circuit board.

11. The LED lamp as claimed in claim 1, further comprising two fixing brackets separated from each other and each having an elongated retaining part, two retaining legs extending downwardly from two opposite ends of the retaining part and two engaging parts extending outwardly and horizontally from two bottom edges of the two retaining legs and attached to a top surface of the casing.

12. An LED lamp, comprising:
a casing comprising a top plate, two side plates extending downwardly from two opposite sides of the top plate and a bottom plate connecting two bottom edges of the two side plates, wherein a light-outputting opening being defined in the bottom plate, a plurality of fixing parts being formed at two facing inner sides of the side plates and spaced from the light-outputting opening with different distances; and
an LED module received in the casing and fixed to one of the fixing parts;
wherein the LED module is fixed selectively to different one of the fixing parts to adjust a distance between the LED module and light-outputting opening.

13. The LED lamp as claimed in claim 12, wherein the fixing parts are arranged at the inner sides of the side plates along a direction parallel to the light-outputting opening.

14. The LED lamp as claimed in claim 12, wherein the fixing parts includes a plurality of pairs of receiving slots, each pair of the receiving slots formed in two corresponding places of the inner sides of the side plates and provided for receiving two lateral portions of the LED module therein.

15. The LED lamp as claimed in claim 14, wherein a plurality pairs of fixing plates extend inwardly and horizontally from the inner side walls of the side plates, each pair of the fixing plates defining one of the receiving slots therebetween and provided for sandwiching one of the two lateral portions of the LED module therebetween.

16. The LED lamp as claimed in claim 12, wherein a plurality of fixtures downwardly extend through the top plate of the casing and the fixing plates in sequence and engage a top surface of the LED module.

17. The LED lamp as claimed in claim 12, wherein the casing further comprises a lens overlying a top surface of the bottom plate and covering the light-outputting opening and two locking plates which extend inwardly and horizontally from the inner side walls of the two side plates and engage a top of the lens.
